(19) United States
(12) Patent Application Publication
(10) Pub. No.: US 2026/0267944 A1
(43) Pub. Date: Sep. 10, 2026

(54) CONTEXT-AWARE ATTRIBUTION OF AI-GENERATED TEXT USING MULTI-DIMENSIONAL INFERENCE PATTERN TENSORS

(71) Applicant: Purdue Research Foundation, West Lafayette, IN (US)

(72) Inventors: Xiangyu Zhang, West Lafayette, IN (US); Hanxi Guo, West Lafayette, IN (US); Zhuo Zhang, West Lafayette, IN (US)

(73) Assignee: Purdue Research Foundation, West Lafayette, IN (US)

(21) Appl. No.: 19/556,603

(22) Filed: Mar. 4, 2026

Related U.S. Application Data
(60) Provisional application No. 63/766,744, filed on Mar. 4, 2025.

(51) Int. Cl. G06F 21/16; G06F 40/284; G06N 20/00

(52) U.S. Cl. CPC G06F 21/16; G06F 40/284; G06N 20/00

(57) ABSTRACT

A system is provided for identifying a source language model that generated an input text. The system may tokenize the input text to generate a token sequence and execute a surrogate neural language model on the token sequence to obtain output logits representing internal inference states of the surrogate neural language model. The system may generate context loss sequences by computing cross-entropy losses between output logits and adjacent tokens within a fixed context window. From the context loss sequences, the system may extract a multi-dimensional inference pattern tensor that includes independent pattern features derived from individual context loss sequences and correlated pattern features derived from pairwise relationships between context loss sequences. A classifier model is executed based on the multi-dimensional inference pattern tensor to identify an originating language model associated with the input text.

### CROSS REFERENCE TO RELATED APPLICATIONS

This application claims the benefit of U.S. Provisional Application No. 63/766,744 filed Mar. 4, 2026, the entirety of which is hereby incorporated by reference.

### TECHNICAL FIELD

This disclosure relates to information security and, in particular, origination sourcing for artificial intelligence content.

### BACKGROUND

With the increasing capabilities of Large Language Models (LLMs), the proliferation of AI-generated texts has become a serious concern. Given the diverse range of organizations providing LLMs, it is crucial for governments and third-party entities to identify the origin LLM of a given text to enable accurate infringement detection and mitigation of potential misuse. However, existing detection methods, primarily designed to distinguish between human-generated and LLM-generated texts, often fail to accurately identify the origin LLM due to the high similarity of AI-generated texts from different sources.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 Illustrates a first example of a system for context aware attribution of artificially generated text.

FIG. 2 illustrates a flow chart of logic for a system.

FIG. 3 Illustrates a second example of a system.

### DETAILED DESCRIPTION

As Large Language Models (LLMs) achieve superior capabilities in understanding and generating human-like text, they have become deeply integrated into everyday life. However, this growing reliance on LLMs has also raised significant concerns regarding the misuse of AI-generated content.

One key aspect of adhering to emerging legal and ethical frameworks is the ability to detect the origin of AI-generated text. A large number of detection techniques have recently been developed. Some of these techniques are based on watermarking. These techniques typically involve fine-tuning LLMs or adjusting their decoding processes to produce text with a distinctive, model-specific distribution. For example, after watermarking, text produced by ChatGPT would exhibit a different distribution from text generated by other LLMs. While watermarking can be effective, it is exclusively controlled by model providers, creating a potential conflict of interest. Since providers are the only entities capable of verifying watermarks, they may be incentivized to obscure evidence of misuse and avoid admitting fault, undermining transparency and accountability.

To mitigate this limitation, surrogate-model-based methods have gained increasing attention. These techniques enable external parties to conduct forensic analyses without requiring cooperation from model providers, relying only on black-box access to the text generation process. By feeding partial or full text to a surrogate model (i.e., an LLM with comparable capabilities), researchers can analyze its internal states to infer the likely origin of the text. The underlying rationale is that sufficiently powerful surrogate models can capture statistical or representational differences, which help reveal the source. Existing approaches along this line largely focus on identifying next-token prediction patterns, referred to as the token-level inference pattern. While these techniques have shown promising results in distinguishing human-generated from AI-generated text, they are less effective in differentiating outputs from various LLMs, as demonstrated in our evaluation. Further investigation reveals that, unlike the clear distinction between human- and AI-generated text, different LLMs often converge on similar next-token predictions due to shared linguistic distributions from large corpora. This similarity introduces a more subtle variation, making token-level inference patterns alone insufficient to capture these nuances.

The disclosed system improves the functioning of computer-based forensic systems by enabling origin attribution of AI-generated text using machine-internal inference behavior that is not accessible or inferable using prior token-level or watermark-based techniques. Prior systems could not differentiate between LLMs because they relied on token-level distributions that converge across models. The disclosed system modifies how inference behavior is measured by introducing context-level cross-entropy relationships, thereby enabling differentiation that prior systems were structurally incapable of performing.

Unlike human-perceptible linguistic analysis, the disclosed techniques operate on high-dimensional probability distributions generated internally by neural language models and require computational processing of output logits across token contexts. These operations cannot be practically performed by a human and are not based on semantic interpretation of text. For example, the system and methods described herein introduce a feature extraction stage that effectively captures contextual information for text origin detection. This system extracts both independent features, i.e., output logits for each token, and correlated features, i.e., pairwise cross-entropy losses between tokens and their neighbors. This approach captures both independent features (i.e., output logits for each token) and correlated features (i.e., pairwise cross-entropy losses between tokens and their neighbors). Based on this, the system and methods described herein in various embodiments provide black-box detection that leverages rich contextual information for identifying the origin of AI-generated text.

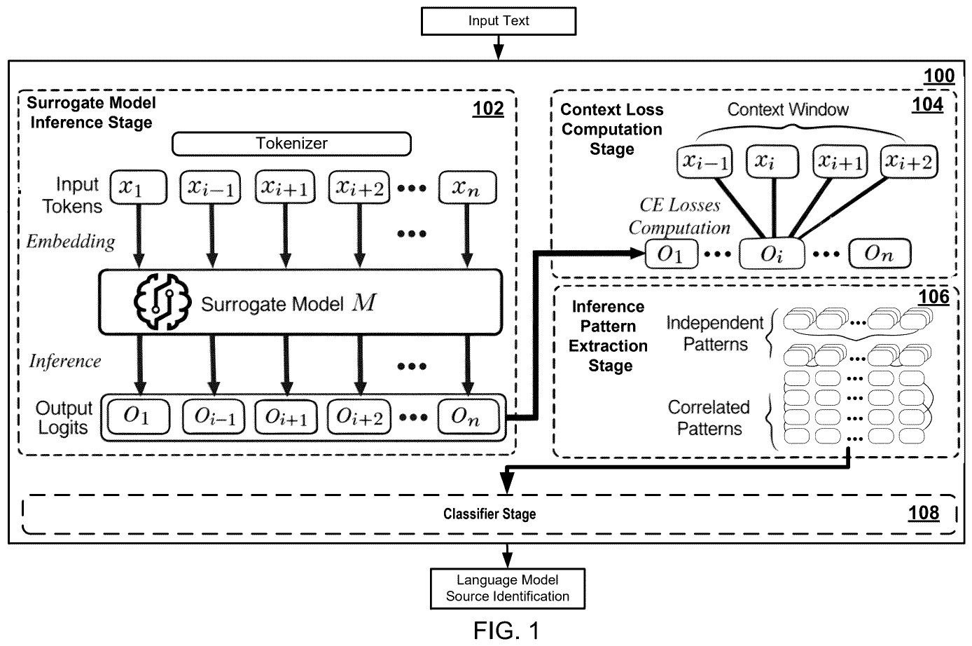

FIG. 1 Illustrates a first example of a system 100 for context aware attribution of artificially generated text. The system 100 may include a pipeline with multiple stages. Each stage may include logic and the term stage may interchangeably be referred to as logic. The system 100 may include a surrogate model inference stage 102, a context loss computation stage 104, an inference pattern extraction stage 106, and a classifier stage 108.

The surrogate model inference stage 102 may include logic where a tokenized input sequence is fed into surrogate model to obtain the sequence of output logits. At each token position, output logits are computed based on all preceding input tokens up to that point. The context loss computation stage 104 may include logic which computes context loss based on the output logits from the previous stage. At each logic position, cross-entropy losses between the current output logits and adjacent input tokens within a fixed context window are calculated. These losses, referred to as context losses, are used in the next stage. The inference pattern extraction stage 106 extracts inference patterns from the context loss. The patterns may include independent patterns (statistical and residual patterns of a single context loss) and correlated patterns (distribution similarity between each context loss pair).

The system 100 may further include a classifier. The extracted patterns may be used to train the classifier (e.g., random forest) for text origin detection during the training phase or fed into a pre-trained classifier to obtain inferences about text origin.

The system 100 may further include a classification stage 108 comprising one or more classifier models. In some embodiments, the multi-dimensional inference pattern tensors extracted from a plurality of training text samples are used to train the classifier model for text origin detection. During a training phase, the system 100 may receive a corpus of training texts for which an originating language model is known. For each training text, the system executes the surrogate neural language model, computes corresponding context loss sequences, and extracts a multi-dimensional inference pattern tensor as described herein.

The extracted multi-dimensional inference pattern tensors are then associated with labels identifying the corresponding originating language models and provided as training inputs to the classifier model. The classifier model may be trained to learn decision boundaries or classification rules that distinguish among different originating language models based on machine-internal inference behavior encoded in the multi-dimensional inference pattern tensors. In some embodiments, the classifier model comprises a random forest classifier; however, other classification techniques may additionally or alternatively be employed without departing from the scope of the disclosure.

In some embodiments, training of the classifier model is performed offline using stored training data and subsequently deployed for use during a runtime inference phase. In other embodiments, the classifier model may be periodically retrained or incrementally updated as additional labeled training samples become available, enabling adaptation to newly introduced language models or model variants.

During an inference phase, the trained classifier model receives a multi-dimensional inference pattern tensor extracted from an input text of unknown origin and generates an identification of a most likely originating language model. In some embodiments, the classifier model directly consumes the multi-dimensional inference pattern tensor; in other embodiments, the tensor is flattened, pooled, or otherwise transformed into a fixed-length feature vector prior to classification.

The training and inference processes described herein operate on machine-internal inference representations derived from probability distributions generated by execution of the surrogate neural language model and do not rely on semantic interpretation of the input text. Accordingly, the classifier model is trained to distinguish originating language models based on differences in contextual inference behavior rather than linguistic meaning or stylistic features.

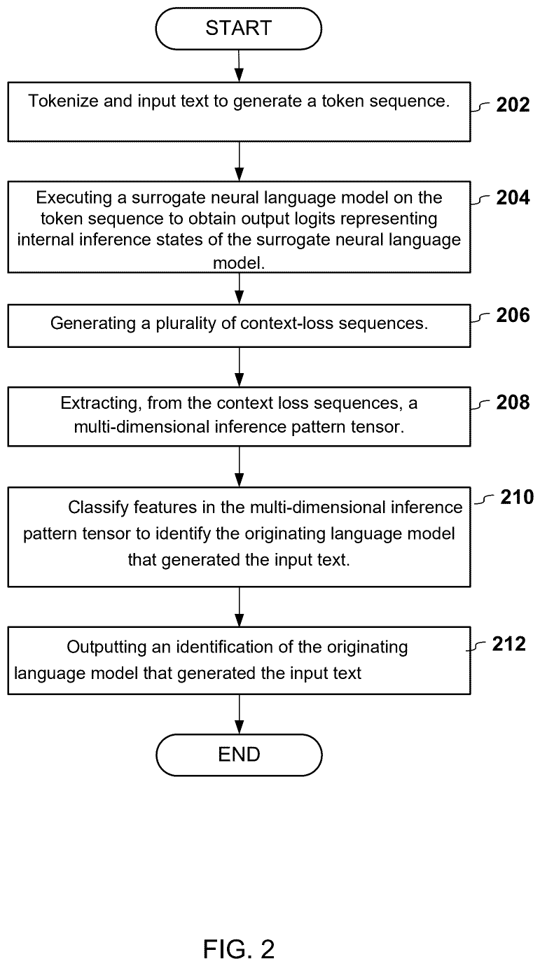

FIG. 2 illustrates a flow chart of logic for the system 100. Reference to FIG. 1 is made through the following discussion. The surrogate model inference stage 102 may receive an input text and generate a token sequence 202. The tokens may be formed by tokenizing the input text. The surrogate model inference stage 102 may obtain, for respective token positions in the token sequence, output logits representing internal inference states of the surrogate neural language model 204. At each respective token position, the output logits are computed based on preceding tokens of the token sequence.

Given the input text to be detected, the surrogate model inference stage first tokenizes the text and feeds the input tokens into the surrogate model M. The surrogate model inference stage then applies the Teacher Forcing algorithm, allowing the surrogate model to infer the input tokens and generate the corresponding output logits sequentially.

Specifically, let the entire input token sequence be x_{1:n}, and each component oᵢ(i∈{1, . . . , n}) in the output logits sequence o_{1:n} is calculated as:

$${o}_{i} = {P}_{M} ( \cdot \vert X = {x}_{1 : i} ) \qquad Eq . 1$$

where P_{M}(⋅|X) represents the probabilities of all the tokens in the surrogate model M's vocabulary list Vas the next token, given the input token sequence X.

The output logits sequence o_{1:n} reflects the surrogate model M's next-word or next-few-words predictions, based on its internal knowledge and preferences, and also contains the reduced information of the input tokens up to each position in the sequence. This sequence of output logits o_{1:n} is then used in the next stage to compute the context losses, capturing the inference pattern of the surrogate model with respect to the input text. Notably, although the surrogate model M differs from the origin model of the input text in terms of architecture, size, and training methodology, the potentially overlapping training data and its powerful statistical and representational understanding capabilities make it a promising tool for uncovering hidden features embedded within the given text.

The context loss computation stage 104 may generate a plurality of context-loss sequences 206. Each context-loss sequence may correspond to a respective token position. The context-loss sequences may be generated by computing cross-entropy losses between (i) the output logits at the respective token position and (ii) adjacent input tokens within a fixed context window relative to the respective token position. In some examples, the adjacent input tokens comprise input tokens at different relative offsets within the fixed context window, including at least one preceding token and at least one succeeding token relative to the given token position. Each context loss sequence may a plurality of cross-entropy losses computed for different relative offsets within the fixed context window. The fixed context window may a predetermined number of token positions centered on the respective token position.

Compared with existing detection techniques that primarily utilize next-word prediction information contained in the output logits. The context loss computation stage 104 captures and analyzes the information of the surrounding input context at each output position (i.e., inference pattern) by calculating and comparing the cross-entropy losses between each component in the output logits with its adjacent input tokens. These losses are denoted as context losses L^{c}. The system 100 utilizes a hyper-parameter W to control the width of the analyzed context at each component of the output logits. The system 100 also drops some of the output logits in o_{1:n} if they lack sufficient context. For example, the first token lacks context from preceding tokens, while the last token lacks context from subsequent tokens. Hence, L^{c}∈ [symbol] ^{W×(n-W)}. Note that we expect the context to be symmetric (an equal number of preceding and subsequent tokens), and thus W is always an even number.

For each context loss L^{c}^{ⱼ}∈L^{c}, where j∈{1, . . . , W}, context loss computation stage 104 computes its component at each position i∈{1, . . . , n−W} as:

$${ℒ}_{i}^{{C}_{j}} = - {\sum }_{v = 1}^{‖ V ‖} {\overline{P}}_{i - 1 + j}^{v} \cdot log {o}_{i - 1 + \frac{W}{2}}^{v} \qquad Eq . 2$$

where V is the vocabulary of the surrogate model M, and \tilde{P}ₖ∈ [symbol] ^{|V|×1} is the one-hot encoded vector of input token xₖ over the vocabulary list V. The calculated context losses L^{c}=[L^{c}^{₁}, . . . , L^{c}^{_{w}}] are then used in the next stage to extract the inference pattern.

With the calculated context losses L^{c}, the inference pattern extraction stage 106 then extracts a multi-dimensional inference pattern tensor of the surrogate model M regarding the token sequence x_{1:n}, including independent patterns and correlated patterns. 208

The inference pattern extraction stage 106 may extract, from the context loss sequences, a multi-dimensional inference pattern tensor. The multi-dimensional inference pattern tensor is a machine-internal data structure derived from the context loss matrix L^{c}∈ [symbol] ^{W×(n-W)}, comprising tensor elements that encode (i) statistical and residual features computed from individual context loss sequences L^{(c}^{ⱼ}⁾ and (ii) divergence-based relational features computed between pairs of context loss sequences, for use in language-model origin attribution.

The multi-dimensional inference pattern tensor thus provides a unified machine-internal representation that captures both within-sequence inference behavior and cross-sequence relational inference behavior of the surrogate neural language model M. The tensor is stored in non-transitory memory and is used as an input to classification logic for identifying an originating language model associated with the token sequence. The tensor is generated through computational processing of high-dimensional probability distributions and is not based on semantic interpretation of the input text.

### Independent Pattern Features.

For each context loss L^{c}^{ⱼ}∈L^{c}, the inference pattern extraction stage 106 first analyzes it independently from other context losses in L^{c}. The features extracted from a single context loss are referred to as independent patterns IP, which include both statistical and residual features, representing how each input token in the context is encoded in the output logits during the surrogate model inference. The statistical features s^{j} of each L^{c}^{ⱼ} may include average, minimum, maximum, standard deviation, median, and/or variance. The residual features, which are first utilized by the inference pattern extraction stage 106 in AI-generated text origin detection, include the statistical properties of the discrete differences and second-order central differences for each context loss L^{c}^{ⱼ}. Specifically, the discrete differences d^{j} for L^{c}^{ⱼ} are calculated as:

$${d}_{j}^{k} = {L}_{k + 1}^{{C}_{j}} - {L}_{k}^{{C}_{j}} , for k ∈ \{ 1 , … , n - W - 1 \} \qquad Eq . 3$$

and the second-order central differences g^{j} for L^{c}^{ⱼ} are approximated as:

$${g}_{j}^{k} = \frac{{L}_{k + 1}^{{C}_{j}} - {L}_{k}^{{C}_{j}} ,}{2} , for k ∈ \{ 2 , … , n - W - 1 \} \qquad Eq . 4$$

where

$${g}_{j}^{1} = {L}_{2}^{{C}_{j}} - {L}_{1}^{{C}_{j}} , and {g}_{n - W}^{1} = {L}_{n - W}^{{C}_{j}} - {L}_{n - W - 1}^{{C}_{j}} .$$

Thus, the independent patterns of all the context losses can be represented as

$$IP = [ \begin{matrix}{s}^{1} , … , {s}^{2} , & {\hat{d}}^{1} , … , {\hat{d}}^{w} , {\hat{g}}^{1} , … , {\hat{g}}^{w}\end{matrix} ] ,$$

where \hat{d}^{j} and ĝ^{j} represent the statistical properties of the discrete differences d^{j} and second-order central differences g^{j}, respectively. These components have the same size as the corresponding s^{j} values.

### Correlated Pattern Features.

The correlated patterns, denoted as CP, capture how differently the input tokens in the context are encoded in the output logits during surrogate model inference. The inference pattern extraction stage 106 may formulate the correlated patterns as the Symmetric Kullback-Leibler (KL) Divergence between each context loss pair [symbol] L_{c}_{ⱼ}, L_{c}_{ₖ} [symbol] , which is calculated as:

$${D}_{j , k} = D ( {L}^{{C}_{{j}^{′}}} ‖ {L}^{{C}_{{j}^{′}}} ) + D ( {L}^{{C}_{{j}^{′}}} ‖ {L}^{{C}_{{j}^{′}}} )$$

where L^{c}^{ⱼ}′ is the soft-maxed version of L^{c}^{ⱼ}, and D represents the KL Divergence. Therefore, the correlated patterns CP consist of

$$( \begin{matrix}W \\ 2\end{matrix} )$$

Symmetric KL Divergence values.

The classification logic may then execute a classifier model, based on the inference patterns, to identify an originating language model that generated the input text 210. The classification logic utilizes the complete inference pattern [IP, CP] of the input token sequence x_{1:n} to either train a classifier (e.g., random forest) during the training phase or predict the given text's origin during testing.

The classifier may receive the multi-dimensional inference pattern tensor directly. In some embodiments, the multi-dimensional inference pattern tensor is flattened, pooled, or otherwise reduced along one or more dimensions to generate a fixed-length feature vector prior to classification.

The system 100 may output an identification of the originating language model that generated the token sequence 212. The identification may correspond to a specific neural language model, a version or variant of a neural language model, a class or family of neural language models, or an indicator distinguishing among a plurality of candidate language models evaluated by the system 100.

In some embodiments, the identification comprises a discrete label, identifier, index, or model designation selected from a predefined set of candidate language models. In other embodiments, the identification comprises a probabilistic or confidence-weighted output, such as a score, ranking, likelihood value, or distribution over multiple candidate language models, from which a most likely originating language model is determined.

The identification is generated based on machine-internal inference behavior encoded in the multi-dimensional inference pattern tensor and is not based on semantic interpretation of the input text. The identification may be stored, transmitted, logged, or provided as input to downstream computer-based systems, including forensic, compliance, monitoring, or content-provenance systems, for purposes of attributing origin of AI-generated content.

### Experimental Results

The system and methods described herein were analyzed in various embodiments. The system was referred to as PROFILER for these experiments. The experimentation and results provide non-limiting examples of the technical advantages provided by the system and methods described herein.

### Datasets.

To comprehensively evaluate the proposed PROFILER, six datasets are used, consisting of two short natural language datasets, two long natural language datasets, and two code datasets. Specifically, the two short natural language datasets include an academic text dataset and a review-style dataset, which consist of both formal and casual texts. The two long natural language datasets include a creative writing dataset and an essay dataset, which contain creative writing samples and student essays, representing fields where misuse of large language models is a significant concern. The two code datasets include a short Python code dataset and a long C++ code dataset, covering programming tasks of different lengths and complexity levels. Notably, a more realistic long C++ code dataset is introduced to the AI-generated text detection field. All AI-generated texts are sourced from five recent commercial large language models including GPT-3.5-Turbo, GPT-4-Turbo, Claude-3-Sonnet, Claude-3-Opus and Gemini-1.0-Pro. We also collect the corresponding paraphrased versions of the six datasets following existing studies to test the robustness of the detection.

### Baselines.

We compare PROFILER with 10 state-of-the-art baselines, which include six zero-shot detection baselines and four supervised-trained detection baselines. The zero-shot baselines include LogRank, LRR, DetectGPT, RADAR, OpenAI Detector, and Binoculars. Note that we use officially released detection models of RADAR and OpenAI Detector to evaluate the samples, making these two supervised-trained baselines operate in a zero-shot pattern. The four supervised-trained detection baselines include Raidar, GhostBuster, Sniffer, and SeqXGPT, with Sniffer and SeqXGPT explicitly claiming and evaluating text origin detection capabilities. We evaluate PROFILER and all baselines in a one-vs-all setting for each text origin, which is a standard evaluation approach in origin detection tasks and is suitable for the existing baselines, as several of them are originally designed for binary classification.

### PROFILER's Hyper-Parameter Settings.

We typically set the context window size W for PROFILER to 6 in most experiments, except for ablation studies. PROFILER employs six open-source large language models as surrogate models and explores the contribution of each, including models of different sizes and architectures. Notably, these surrogate models are also used by other baseline methods for comparative analysis.

### Detection Performance on Natural Language Datasets—

We first evaluate PROFILER against 10 baselines on natural language datasets, including both the original and paraphrased versions of the texts in both the in-distribution and out-of-distribution (OOD) settings. Overall, under the in-distribution setting, PROFILER outperforms all 10 baselines, achieving an average improvement of more than 0.30 (45% ↑) in AUC score. Under the out-of-distribution (OOD) setting, PROFILER continues to surpass existing baselines, demonstrating an average AUC score improvement of more than 0.11 (13% ↑). Detailed analysis is shown as follows.

In-distribution Performance—For each method, we report the 5-fold cross-validated average AUC score. We first evaluate PROFILER alongside 10 baselines on the original dataset. The results highlight the limitations of zero-shot detection methods in identifying the origin of a text, as all zero-shot baselines achieve only around 0.5 average AUC across the six text origins, despite occasionally performing well on specific origins. In contrast, supervised-trained baselines, which leverage more complex features, exhibit significantly better average performance, achieving 0.30 (46% ↑) AUC increase on average. Compared to the zero-shot baselines, PROFILER achieves more than a 0.43 (85% ↑) increase in average AUC score. Additionally, PROFILER outperforms the four supervised-trained baselines by more than 0.10 (12% ↑) in average AUC score. Notably, PROFILER surpasses Sniffer and SeqXGPT—two supervised-trained baselines specifically designed for text origin detection—by 0.05 (6% ↑) and 0.12 (15% ↑) higher AUC scores on average, respectively.

We further evaluate PROFILER and all baselines on the paraphrased datasets using the same evaluation methodology. Similarly, all zero-shot baselines achieve only around a 0.5 average AUC score, while supervised-trained baselines reach an average AUC of 0.31 (44% ↑). PROFILER outperforms the zero-shot baselines by more than 0.44 (78% ↑) in average AUC and surpasses the supervised-trained baselines by more than 0.11 (12% ↑) on average. While paraphrasing is typically an effective technique to test the robustness of detection methods in the binary AI-generated text detection domain, its impact is reduced in the text origin detection domain, as indicated by the consistent results of supervised-trained baselines and PROFILER across both original and paraphrased datasets. We attribute this to two reasons: (1) all the supervised-trained baselines evaluated in this work are designed to be robust to paraphrasing, and (2) the paraphrasing process may reveal more distinctive characteristics of a specific language model, thereby providing additional information for text origin detection.

The above results emphasize the superior effectiveness of PROFILER in accurately identifying the originating language model of a text under the in-distribution setting.

### Out-of-Distribution (OOD) Performance.

Following the in-distribution evaluation, we also assess PROFILER and the baselines under a more realistic out-of-distribution (OOD) setting. Given the poor performance of zero-shot methods in the in-distribution setting, we consider only supervised-trained baselines for the OOD evaluation. PROFILER and the four supervised-trained baselines are trained on the original datasets and tested on the paraphrased versions of the same datasets. The out-of-distribution (OOD) experiments aim to evaluate the robustness of the detectors against customized prompts (e.g., paraphrasing prompts in these experiments) used during large language model text generation. PROFILER outperforms all four baselines across the four natural language datasets, achieving an average AUC improvement of 0.11 (13% ↑). Specifically, under the OOD setting, PROFILER demonstrates a 0.13 (15% ↑) increase in average AUC on the two short natural language datasets compared to the baselines, while exceeding the baselines by more than 0.09 (11% ↑) average AUC on the two long natural language datasets. These results not only highlight PROFILER's superior detection performance across different natural language datasets in the OOD setting but also show its significant advantage in handling short text inputs, which have been regarded as a more challenging scenario in prior work.

In real-world deployment, detection methods are expected to achieve a high true positive rate (TPR) while maintaining a low false positive rate (FPR). Therefore, we further analyzed the ROC curves of PROFILER and the four supervised-trained baselines under the OOD setting using a representative review-style dataset. Specifically, PROFILER achieves an average TPR of over 0.5 when the FPR is less than 0.1. It is important to note that these results are evaluated under the OOD setting; PROFILER would demonstrate even better performance under the in-distribution setting.

### 5.3 Detection Performance on Code Datasets—

Existing detection methods are rarely evaluated on code datasets. However, with the rapid development and deployment of coding assistants, the misuse of large language models in generating code has become an increasingly important issue. In these experiments, we further evaluate PROFILER and all the baselines not only on the short HumanEval dataset, but also on a more realistic long-form code dataset, which is collected specifically for this study. The long-form code dataset consists of approximately 274 long C++ code samples (greater than 200 lines) for each text-origin language model used in the aforementioned natural language experiments, providing a more comprehensive evaluation of detection methods on real-world code data.

According to the results, PROFILER outperforms existing baselines by more than 0.29 (46% ↑) in average AUC score under the in-distribution setting and achieves more than 0.10 (12% ↑) higher average AUC score under the out-of-distribution (OOD) setting on the two code datasets. Detailed results are provided as follows.

In-distribution Performance—According to the results presented in Table 2, PROFILER outperforms existing baselines by more than 0.26 (49% ↑) and 0.32 (43% ↑) in AUC scores on the original and paraphrased datasets, respectively, under the in-distribution setting. Specifically, PROFILER surpasses the zero-shot baselines and supervised-trained baselines by 0.34 (68% ↑) and 0.14 (20% ↑) in AUC score on the original dataset, respectively. These results confirm the inadequacy of zero-shot detection methods in the text origin detection domain, as all zero-shot methods achieve only around a 0.5 AUC score on the two code datasets. Furthermore, PROFILER outperforms Sniffer and SeqXGPT with more than 0.16 (25% ↑) and 0.13 (18% ↑) higher AUC scores, respectively, demonstrating its superior effectiveness in detecting the origin of AI-generated code.

The superiority of PROFILER becomes even more evident on the paraphrased datasets, where PROFILER outperforms the zero-shot baselines and supervised-trained baselines by 0.43 (86% ↑) and 0.14 (18% ↑) in AUC score, respectively, across the two paraphrased code datasets. In particular, PROFILER surpasses Sniffer and SeqXGPT with over 0.15 (19% ↑) and 0.14 (18% ↑) higher AUC scores, respectively.

Out-of-distribution (OOD) Performance—Similar to the OOD evaluation on the natural language datasets, PROFILER and the baselines are also assessed under the OOD setting on the two code datasets. PROFILER outperforms all four supervised-trained baselines across both code datasets, achieving an average AUC improvement of 0.10 (12% ↑). Specifically, under the OOD setting, PROFILER demonstrates a 0.09 (12% ↑) increase in AUC score on the short-form code dataset and a 0.11 (11% ↑) increase on the long-form code dataset.

### 5.4 Ablation Study—

To investigate the impact of each hyper-parameter on PROFILER's performance, several ablation studies are conducted, including the effects of context window size and the choice of surrogate model. The results indicate that the hyper-parameters of PROFILER have limited impact on its overall performance, demonstrating the robustness and compatibility of PROFILER across various configurations.

### Impact of Context Window Size.

PROFILER is evaluated using different context window sizes, specifically W=2,4,6,8, where W=6 is the default configuration. The performance of PROFILER fluctuates within a range of 3% across varying window sizes. When W≤6, a larger window size generally results in a higher average detection AUC. However, when W≥6, the detection AUC begins to degrade. Therefore, W=6 is selected as the default configuration for PROFILER to balance performance and efficiency.

### Impact of Surrogate Model Selection.

The influence of different surrogate models on PROFILER's performance is also evaluated. While some fluctuation in detection AUC is observed, PROFILER demonstrates consistent performance across various surrogate language models. In most cases, using a single surrogate model achieves at least 95% of the detection performance of the ensemble version, indicating PROFILER's high generality and compatibility when applied with different surrogate models. This flexibility allows PROFILER to be adapted according to different configurations and resource constraints in real-world deployment scenarios.

The system 100 illustrates in FIG. 1 may be implemented in various ways. In addition, the logic shown in FIG. 2 may have additional, fewer, or different operations than shown.

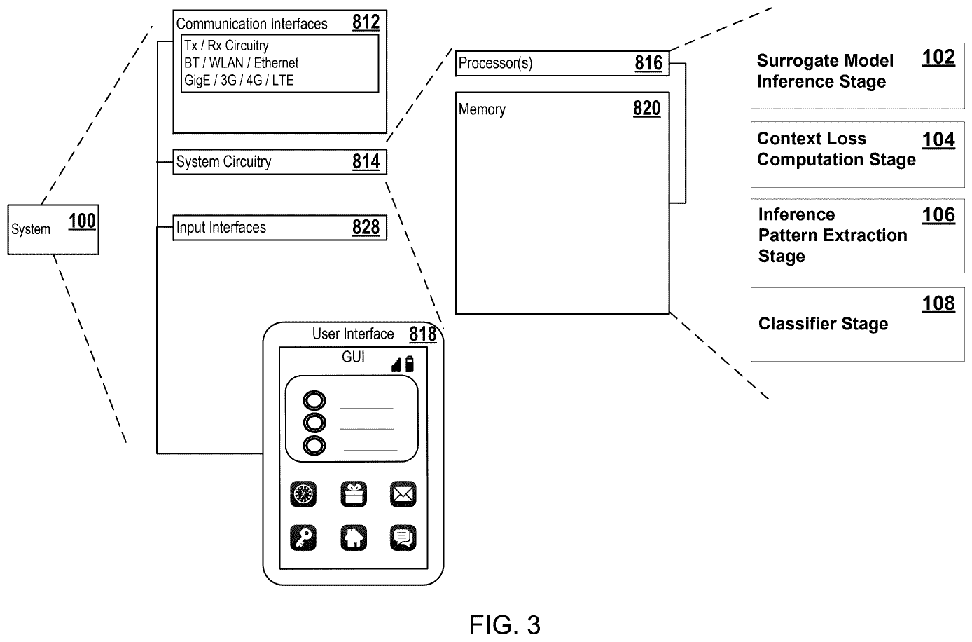

FIG. 3 illustrates a second example of the system 100. The system 100 may include communication interfaces 812, input interfaces 828 and/or system circuitry 814. The system circuitry 814 may include a processor 816 or multiple processors. Alternatively or in addition, the system circuitry 814 may include memory 820.

The processor 816 may be in communication with the memory 820. In some examples, the processor 816 may also be in communication with additional elements, such as the communication interfaces 812, the input interfaces 828, and/or the user interface 818. Examples of the processor 816 may include a general processor, a central processing unit, logical CPUs/arrays, a microcontroller, a server, an application specific integrated circuit (ASIC), a digital signal processor, a field programmable gate array (FPGA), and/or a digital circuit, analog circuit, or some combination thereof.

The processor 816 may be one or more devices operable to execute logic. The logic may include computer executable instructions or computer code stored in the memory 820 or in other memory that when executed by the processor 816, cause the processor 816 to perform the operations surrogate model inference stage 102, context loss computation stage 104, the inference pattern extraction stage 106, and/or the system 100. The computer code may include instructions executable with the processor 816.

The memory 820 may be any device for storing and retrieving data or any combination thereof. The memory 820 may include non-volatile and/or volatile memory, such as a random access memory (RAM), a read-only memory (ROM), an erasable programmable read-only memory (EPROM), or flash memory. Alternatively or in addition, the memory 820 may include an optical, magnetic (hard-drive), solid-state drive or any other form of data storage device. The memory 820 may include at least one of the operations of the surrogate model inference stage 102, context loss computation stage 104, the inference pattern extraction stage 106, and/or the system 100. Alternatively or in addition, the memory may include any other component or subcomponent of the system 100 described herein.

The user interface 818 may include any interface for displaying graphical information. The system circuitry 814 and/or the communications interface(s) 812 may communicate signals or commands to the user interface 818 that cause the user interface to display graphical information. Alternatively or in addition, the user interface 818 may be remote to the system 100 and the system circuitry 814 and/or communication interface(s) may communicate instructions, such as HTML, to the user interface to cause the user interface to display, compile, and/or render information content. In some examples, the content displayed by the user interface 818 may be interactive or responsive to user input. For example, the user interface 818 may communicate signals, messages, and/or information back to the communications interface 812 or system circuitry 814.

The system 100 may be implemented in many different ways. In some examples, the system 100 may be implemented with one or more logical components. For example, the logical components of the system 100 may be hardware or a combination of hardware and software. The logical components may include the operations surrogate model inference stage 102, context loss computation stage 104, the inference pattern extraction stage 106, or any component or subcomponent of the system 100. In some examples, each logic component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each component may include memory hardware, such as a portion of the memory 820, for example, that comprises instructions executable with the processor 816 or other processor to implement one or more of the features of the logical components. When any one of the logical components includes the portion of the memory that comprises instructions executable with the processor 816, the component may or may not include the processor 816. In some examples, each logical component may just be the portion of the memory 820 or other physical memory that comprises instructions executable with the processor 816, or other processor(s), to implement the features of the corresponding component without the component including any other hardware. Because each component includes at least some hardware even when the included hardware comprises software, each component may be interchangeably referred to as a hardware component.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device.

The processing capability of the system may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL).

All of the discussion, regardless of the particular implementation described, is illustrative in nature, rather than limiting. For example, although selected aspects, features, or components of the implementations are depicted as being stored in memory(s), all or part of the system or systems may be stored on, distributed across, or read from other computer readable storage media, for example, secondary storage devices such as hard disks, flash memory drives, floppy disks, and CD-ROMs. Moreover, the various logical units, circuitry and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer and/or central processing unit (“CPU”).

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same apparatus executing a same program or different programs. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

1. A computer-implemented method for identifying a source language model that generated an input text, the method comprising:
tokenizing the input text to generate a token sequence comprising a plurality of tokens;
executing a surrogate neural language model on the token sequence to obtain, for respective token positions, output logits representing internal inference states of the surrogate neural language model, wherein at each respective token position the output logits are computed based on preceding tokens of the token sequence;
generating a plurality of context-loss sequences, each context-loss sequence corresponding to a respective token position, by computing cross-entropy losses between (i) the output logits at the respective token position and (ii) adjacent input tokens within a fixed context window relative to the respective token position;
extracting, from the context loss sequences, a multi-dimensional inference pattern tensor comprising:
(a) independent pattern features computed from at least one context loss sequence, the independent pattern features including statistical features and residual features derived from values of the context loss sequence, and
(b) correlated pattern features computed from pairwise relationships between context loss sequences, the correlated pattern features including similarity metrics computed between pairs of the context loss sequences;
executing a classifier model, based on the multi-dimensional inference pattern tensor, to identify an originating language model that generated the input text; and
outputting an identification of the originating language model that generated the input text.

2. The method of claim 1, wherein the adjacent input tokens comprise input tokens at different relative offsets within the fixed context window, including at least one preceding token and at least one succeeding token relative to the given token position.

3. The method of claim 1, wherein each context loss sequence comprises a plurality of cross-entropy losses computed for different relative offsets within the fixed context window.

4. The method of claim 1, wherein the fixed context window comprises a predetermined number of token positions centered on the respective token position.

5. The method of claim 1, wherein generating the plurality of context loss sequences excludes token positions adjacent to a boundary of the token sequence.

6. The method of claim 1, wherein the independent pattern features include one or more of a mean, a variance, a minimum, a maximum, and a median of the context losses.

7. The method of claim 1, wherein the independent pattern features include residual pattern features comprising statistical properties of discrete differences and second-order central differences of context loss values.

8. The method of claim 1, wherein the correlated pattern features comprise similarity measures between pairs of context loss sequences.

9. The method of claim 8, wherein the similarity measures comprise distribution similarity metrics computed between corresponding context losses of the pairs of context loss sequences.

10. The method of claim 1, wherein determining the originating language model comprises applying the multi-dimensional inference pattern tensor to a trained classifier.

11. The method of claim 10, wherein the trained classifier comprises a random forest classifier.

12. The method of claim 1, wherein the originating language model is selected from a plurality of candidate language models based on the multi-dimensional inference pattern tensor.

13. The method of claim 1, wherein the surrogate neural language model is different from the originating language model.

14. The method of claim 1, wherein executing the surrogate neural language model comprises executing a plurality of surrogate neural language models and aggregating the resulting context loss sequences.

15. The method of claim 1, wherein outputting the identification of the originating language model comprises outputting the identification for use by a computer-based forensic system to attribute provenance of AI-generated content.

16. The method of claim 1, wherein extracting comprises storing the multi-dimensional inference pattern tensor in non-transitory memory as a data structure indexed by token position and context-window offset.

17. The method of claim 1, further comprising retraining or incrementally updating the classifier model based on additional labeled training texts to adapt the classifier model to at least one newly introduced originating language model or model variant.

18. The method of claim 1, further comprising, training the classifier model by;
retrieving a label identifying the origination language model; and
training the classifier model based on the multi-dimensional inference pattern tensor and the label.

19. The method of claim 1, wherein outputting the identification of the originating language model that generated the input text further comprises storing the identification of the originating language model, displaying a representation of the identification of the originating language, or communicating the identification of the originating language model over a network.

20. A system for identifying a source language model that generated an input text, the system comprising:
one or more processors; and non-transitory memory storing computer-executable instructions that, when executed by the one or more processors, cause the system to:
tokenize the input text to generate a token sequence comprising a plurality of tokens;
execute a surrogate neural language model on the token sequence to obtain, for respective token positions, output logits representing internal inference states of the surrogate neural language model, wherein at each respective token position the output logits are computed based on preceding tokens of the token sequence;
generate a plurality of context loss sequences, each context loss sequence corresponding to a respective token position, by computing cross-entropy losses between (i) the output logits at the respective token position and (ii) adjacent input tokens within a fixed context window relative to the respective token position;
extract, from the context loss sequences, a multi-dimensional inference pattern tensor comprising;
(a) independent pattern features computed from at least one context loss sequence, the independent pattern features including statistical features and residual features derived from values of the context loss sequence, and
(b) correlated pattern features computed from pairwise relationships between context loss sequences, the correlated pattern features including similarity metrics computed between pairs of the context loss sequences;
execute a classifier model, based on the multi-dimensional inference pattern tensor, to identify an originating language model that generated the input text; and
output an identification of the originating language model that generated the input text.
